(19) United States
(12) Patent Application Publication
(10) Pub. No.: US 2016/0268858 A1
(43) Pub. Date: Sep. 15, 2016

(54) ELECTRIC MACHINE WINDING WITH CENTRAL COIL

(71) Applicant: Bent GEERTSEN, Cullera (ES)

(72) Inventor: Bent GEERTSEN, Cullera (ES)

(21) Appl. No.: 14/911,656

(22) PCT Filed: Aug. 14, 2013
(86) PCT No.: PCT/ES2013/000200

§ 371 Date: May 31, 2016

(51) Int. Cl. H02K 3/28

(52) U.S. Cl. CPC H02K 3/28

(57) ABSTRACT

Winding in electric machine with center coil in field center in the pair of poles and auxiliary coils in the field of each one of the two poles in the pair of poles in the stator. The two primary coils in each one of the pair of poles in the stator are replaced by a single center coil in the field center in the pole. The power of the electric machine, of the transformer and the coil are dependent on its core area elevated to the square. For the purpose of distribution of the coil powers in an electrical machine with auxiliary coils, use is made of a factor that provides the appropriate load of the stator and rotor cores. The number of slots in the stator is reduced by increasing the number of turns in the center coil in the field. The stator is optimized by means of the use of the square root of the power of a coil over the core area thereof. In hermetically sealed refrigeration compressors, the massive central shaft is accommodated in the rotor. The center core in the transformers is from 2 times reduced to √2 times the height of the ring core.

Winding in electric machine with center coil in the field center in the pair of poles and auxiliary coils in the field of each one of the two poles in the pair of poles in the stator. The rotor of the electric machine is circular due to the rotation on the machine, its area and shape of the core is determined. The stator must ensure adequate field strength in the right places with the help of the winding. The winding provides the required power in the right place by means of one or more coils. The coil power depends on the number of turns in the coil. When the winding consists of several coils in each pole pair in the stator, the power is distributed to the coils using their corresponding area in the rotor core area elevated to the square as the basis for the correct distribution of the load in the machine and the maximum use of the rotor and stator. Each coil n an electrical machine transforms electricity from the stator to the rotor as a transformer. The power of the electric machine is the sum of the powers of the coils and dependent on elevate to the square its core area in the rotor, which is the diameter of the rotor multiplied by the width of the rotor. The power of an electrical machine, of a transformer and of a coil depends on its core area elevated to the square. Power=B×A². Power=W (watt) or VA (volt ampere). B=the flow. A=area of the core.

Make electrical machine winding with center coil in the field center in the pair of poles and auxiliary coils in the field of each of the two poles in the pair of poles in the stator.

In an electrical machine with a coil in each of the two poles of the pair of poles in the stator, the two coils are replaced by one center coil in the field center of each pair of poles in the stator. Make larger the central slot in the pair of poles in the stator and increase the number of turns in the center coil in the field center in the pair of poles in the stator in this slot.

In the universal motor and the DC motor with a coil in each one of the two poles in the pair of poles in the stator to join the two coils on a single center coil in the center of the stator field. The 2 shorted coils separated in 4 slots in the rotor, join in 2 opposing radial slots in the rotor.

The power of electric machines of different sizes are determined on the basis of its core area in the rotor elevated to the square, comprising the rotor diameter multiplied by the width of the rotor.

Make the power of a coil in an electrical machine with the function to elevate to the square its corresponding area in the rotor core by setting the number of turns in the coil proportional to the area, which is the effective width of the rotor multiplied by the chord length in the rotor between the two lines from the rotor center to the two centers of the coil in the stator.

The distance between a slot in the stator and the outer surface of the stator depends on function of the square root of the power of the coil in this slot.

In the hermetically sealed refrigeration compressor having a central shaft with central hole for the lubrication of the unit the shaft is made massive in the rotor in the asynchronous motor.

As the coils in the electric machine, the transformer core and a coil is configured in function of its core area elevated to the square.

Multi polar electrical machines can be winded with center coil with or without auxiliary coils in each pair of poles in the stator. Multi-phase electric machines can be winded on the same principle as in the invention, by winding a single-phase electric machine for each phase.

The existing electrical machines.

The electrical machine has a winding with a primary coil with or without auxiliary coils in each one of the two poles in each pair of poles in the stator. The volume of the rotor is used as a basis for calculating the power of an electric machine. When there are auxiliary coils in an electrical machine, there is no known effective method of calculating the distribution of the power and the number of turns between the coils providing the appropriate loading of the rotor core and stator core. When a coil has many turns, it absorbs more energy. This causes heat accumulation, further temperature rise that may cause possible burning of insulation and short-circuit in the coil. The power factor (cos φ) and efficiency is also reduced. This heating is a waste of energy. Is almost always the smaller coil which burns out due to too many turns, while the coil is the more enclosed. The universal motor and DC motor haves a coil on each one of the two poles of the pole pair in the stator. There are 2 short-circuited coils separated in 4 slots in the rotor.

The hermetically sealed refrigeration compressor has a central shaft with a central hole for the lubrication of the unit. When the lubricating oil appears in the rotor, increase the consumption of energy significantly and the motor run with lower speed.

Improvements.

By distributing the powers of the coils using its corresponding core area in the rotor elevated to the square as base the power apparently effect (VA) (volt ampere) improved approximately 25% in small asynchronous motors with the current design of the rotor and stator. The power factor (cos φ) and efficiency improved significantly. By adapting the design of the stator and rotor efficiency can be further improved. Generates less heat and there is less possibility to burn out the winding. The need for cooling is also reduced. Copper consumption is nearly the same as the current, but with a smaller cross section.

By making larger the center slot in the in the center of the field in the pole pair in the stator and increase the number of turns in the center coil in the field in this slot may reduce the number of slots and auxiliary coils in the stator.

When universal motor and DC motor with a coil in each one of the two poles in the pole pair in the stator united in a single central coil in the center of the field and the 2 short-circuited coils separate in 4 slots in the rotor joined in 2 opposing radial slots in the rotor increases the motor efficiency.

When in the existing hermetically sealed refrigeration compressor with the central shaft with central hole for the lubrication of the unit to make the shaft massive inside the rotor in the asynchronous motor increases the area of the rotor core and the lubricating oil does not reduce the electric field, prevents the increased energy consumption and the motor is not functioning with lower speed.

When the stator is outside the rotor, the outer shape is made by the distance between a slot in the stator and the outer surface of the stator depends on the square root of the power in the coil in the slot. Stator design in European Patent No. 88300380.3 has a different basis for the design of the outer surface of the stator of single phase induction motors and does not give the same result.

The invention is explained with the following figures:

The start winding is not included. This is wounded by the same rules.

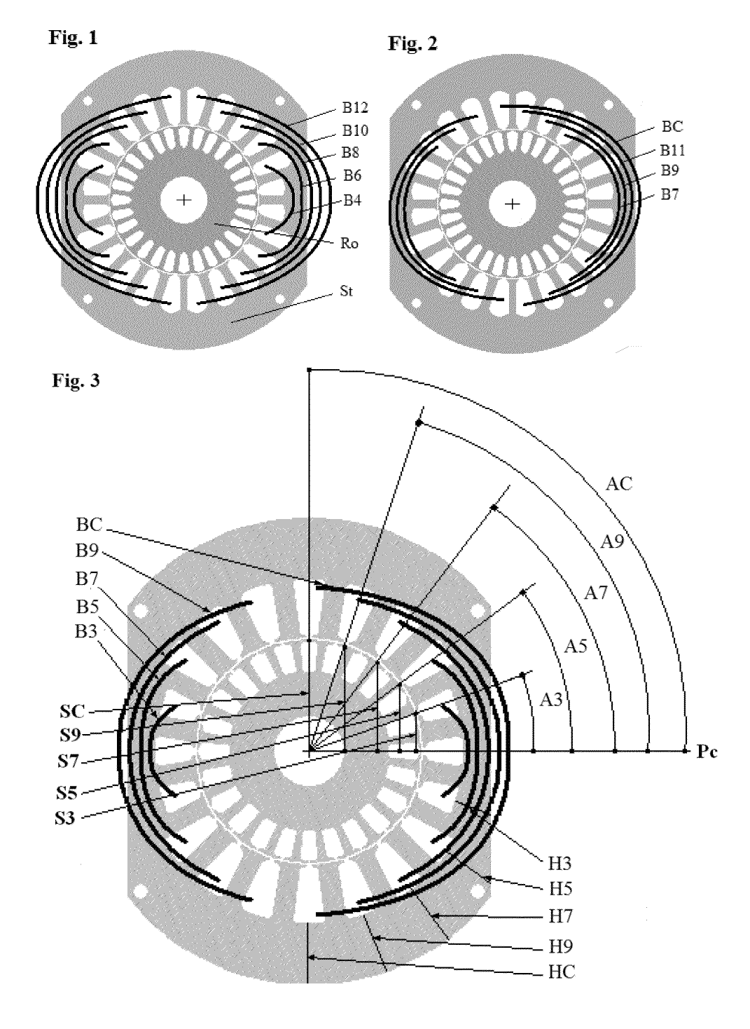

FIG. 1 shows the winding in an existing single phase asynchronous motor with a stator (St) with 24 slots. Ro=rotor. St=stator. B12=primary coil. B10=auxiliary coil. B8=auxiliary coil. B6=auxiliary coil. B4=auxiliary coil.

FIG. 2 shows the same motor as FIG. 1 with winding with center coil (BC) in the center of the field in the pole pair and auxiliary coils (B) in the field of each one of the two poles of the pair of poles in the stator. B11=auxiliary coil. B9=auxiliary coil. B7=auxiliary coil.

FIG. 3 shows the winding for a stator with two poles, 20 slots with center core (BC) in the center of the field in the pole pair and auxiliary coils (B) in each pair of poles in the stator (St). Auxiliary coils (B) are numbered according to the number of slots that they cross. Its corresponding angle (A) and sine A in the rotor (Ro) and the distance (H) are numbered with the same number. H=the distance between a slot in the stator and the outer surface of the stator (St). Signs used are shown in the following table:

| Coils | Angles | Sine A | Distance H |
|---|---|---|---|
| Central coil BC | AC | SC | HC |
| Auxiliary Coil B9 | A9 | S9 | H9 |
| Auxiliary Coil B7 | A7 | S7 | H7 |
| Auxiliary Coil B5 | A5 | S5 | H5 |
| Auxiliary Coil B3 | A3 | S3 | H3 |

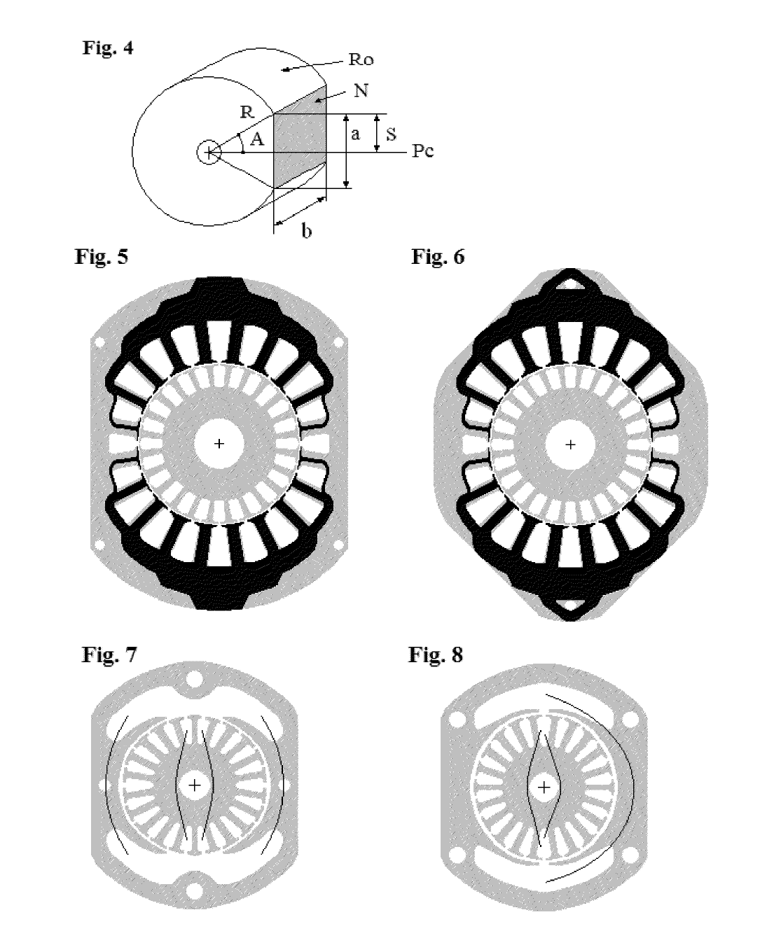

FIG. 4 shows the core area (N) in the rotor (Ro) corresponding to a coil (B) in the stator (St). The area of the core (N) is shown in gray color. Ro=rotor core. b=width of the rotor. R=radius of rotor (Ro). N=area of the rotor core that corresponds to the coil (B) in the stator (St). a=length of the chord in the rotor (Ro)=height of the core (N). Pc=the center line of the pole. A=the angle between the centerline of the pole (Pc) and the line (R) from the center of rotor (Ro) to one of the two centers of the coil (B) in the stator. S=sine A

FIG. 5 shows the shape of the stator with winding with center coil in field center and auxiliary coils in the pole pair. The shape of the calculated stator is shown with black color.

FIG. 6 shows the stator with 2 holes for mounting. The shape of the calculated stator is shown with black color.

FIG. 7 shows the universal motor and the DC motor with the current winding. The two coils in the stator are shown with black colored line. The 2 short-circuited coils in 4 slots in the rotor are shown with black colored line.

FIG. 8 shows the universal motor and DC motor with single center coil in the center of the field in the stator. The single center coil is shown with the black colored line. The 2 short-circuited coils together in the same two opposing radial slots in the rotor are indicated by black line.

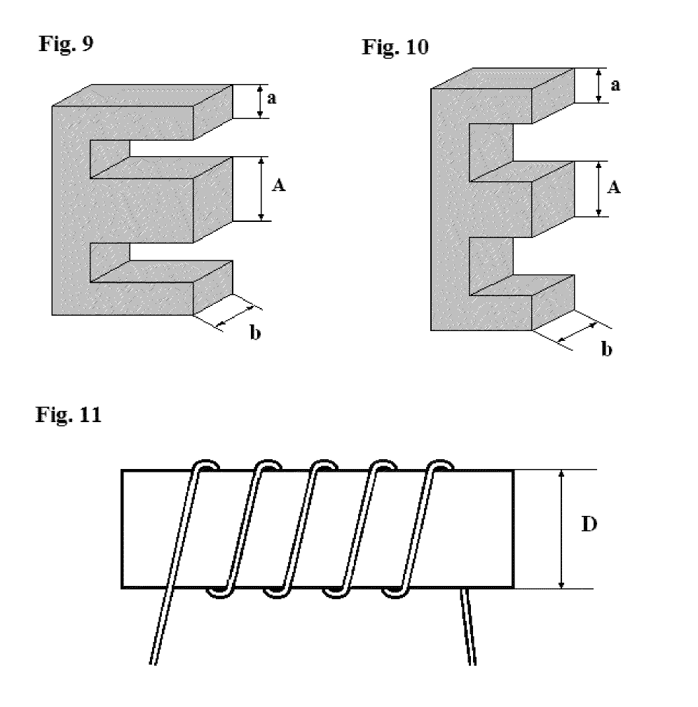

FIG. 9 shows the current design of the transformer core. A=height of the center core. a=the height of the ring core. b=width of the core

FIG. 10 shows the shape of the transformer core set up according to its core area elevated to the square. A=height of the center core. a=the height of the ring core. b=width of the core.

FIG. 11 shows a coil with a circular core. D=diameter of the core.

### DETAILED DESCRIPTION OF THE INVENTION

Use a single phase asynchronous motor in a hermetically sealed refrigeration compressor with 20 slots in the stator (St) as an example. Start winding is not included. This is wounded by the same rules.

Refer to FIG. 3 and FIG. 4. The center coil (BC) in the center of the pair of poles in the stator (St) has the diameter of rotor (Ro) times the width (b) of the rotor (Ro) as core area INC). Auxiliary coils (B) in the field in each one of the two poles in the pair of poles in the stator (St) are numbered according to the number of slots they cross. Their corresponding angle (A) and sine A in the rotor (Ro) and the distance (H) are numbered with the same number. The coils (B) in the motor winding are connected in series and therefore have the same amperage. The width of the core area (b) is the same as the effective width (b) of the rotor (Ro). The angle (A) is between the center line (Pc) of the pole and the line (R) extending from the center of the rotor (Ro) to one of the two centers of the coil (B) in the stator (St).

The height (a) of the core of a. coil (B) is the same as the chord (a) in the rotor (Ro) between the lines that extends from the center of the rotor (Ro) to the two centers of the coil (B) in the stator (St). In order to achieve the same flow loading the numbers of turns in the coil (B) have to be proportional to the area of the core (N) corresponding in the rotor (Ro). The power of the coil (B) depends on its corresponding core area (N) in the rotor (Ro) elevated to the square. The width (b) of the cores (N) is equal and the number of turns of the coil (B) will be proportional to its height (a) of the core (N) in the rotor (Ro). The power in the coil (B) is dependent on the height (a) of the core (N) in the rotor (Ro) elevated to the square.

The chord length (a) in the rotor (Ro) is the radius (R) of the rotor (Ro) 2 times sine A. The radius (R) of the rotor (Ro) is constant. Sine A can be used as the distribution factor of the number of turns in each coil (B) in the motor winding and applies to all electrical machines of all sizes with auxiliary coils in the winding.

Sine² A is used as the allocation factor to the proportion of the power of the coils (B) and applies to all electric machines of all sizes with auxiliary coils in the winding.

The sum of the powers of the coils (B) is the motor power. The motor depends as the center coil (BC) in the center of the field in the pole pair by function to elevate to the square its core area (NC) in the rotor, comprising the rotor diameter multiplied by the width (b) of the rotor (Ro).

For a stator (St) with two poles, 20 slots, winding with center coil (BC) in the center of the field in the pole pair and auxiliary coils (B) in the field of each one of the two poles of the pair of poles the distribution of the number of turns between the coils (B) would be as shown in the following table:

| Coils | Angles A | | Factor | | | Coils |
|---|---|---|---|---|---|---|
| Signs | Signs | Grades | Sine A | Distribution | Sum | Number of turns |
| BC | AC | 90 | 1 | 1 × 1 | 1 | 1 × Fs |
| B9 | A9 | 72 | 0.95 | 2 × 0.95 | 1.9 | 0.95 × Fs |
| B7 | A7 | 54 | 0.81 | 2 × 0.81 | 1.62 | 0.81 × Fs |
| B5 | A5 | 36 | 0.59 | 2 × 0.59 | 1.08 | 0.59 × Fs |
| B3 | A3 | 18 | 0.31 | 2 × 0.31 | 0.62 | 0.31 × Fs |

| | | |
|---|---|---|
| Sum | 6.52 | Sum of motor |

Fs = Sum of motor/6.52.

When the distance between a slot and the outer surface of the stator is provided, the other distances (H) must adapt to its factor sine A. Signs refer to FIG. 3. For a stator (St) with two poles, 20 slots, with winding with center coil (BC) and auxiliary coils (B) the distances (H) would be as shown in the following table:

| Coils | Angles A | | Factor | Stator |
|---|---|---|---|---|
| Signs | Signs | Grades | Sine A | Distance H |
| BC | AC | 90 | 1 | HC |
| B9 | A9 | 72 | 0.95 | H9 |
| B7 | A7 | 54 | 0.81 | H7 |
| B5 | A5 | 36 | 0.59 | H5 |
| B3 | A3 | 18 | 0.31 | H3 |

The resulting shape of the stator (St) is shown in FIG. 5, with two mounting holes in FIG. 6 with black color. In regard to installation in the machine, some distance (H) from the slots to the outer surface of the stator (St) is greater than necessary and the number of turns in the coil (B) is adjusted so that they get the right power with respect to the rotor (Ro).

An existing single-phase asynchronous motor with one primary coil and 4 auxiliary coils in each one of the two poles in the in the pair of poles in the stator shown in FIG. 1 was replaced with a center coil in the center of the field and 3 auxiliary coils in each one of the two poles in the pole pair in the stator, as shown in FIG. 2 with an energy saving of 22.5% and a saving of 16.5% copper.

The transformer core in the current configuration is shown in FIG. 9. Core height (A) is equal to 2 times the height of the ring core (a): A=2*a. The resulting transformer core from elevating to the square its core area is shown in FIG. 10: The height of the core (A) is equal to √2 times the height of the ring core (a): A=√2*a. At the same time the window can be made squarer and the center of the core (A) and the ring core (a) will be shorter.

The coil shown in FIG. 11 has its power in function of elevating to the square the core area. The same for air-cored coils. When the coil is accomplished with square core, there are the same rules as for transformers.

1.-9. (canceled)

10. A winding in electric machine, comprising: a center coil in afield center in a pair of poles, and auxiliary coils in the field of each one of the two poles in the pair of poles in the stator.

11. The winding in electric machine with center coil according to claim 10, further comprising a coil in each one of the two poles in the pair of poles in the stator, and two coils with a single center coil in the center of the field in each pair of poles in the stator.

12. The winding in electric machine with center coil according to claim 10, further comprising making the center slot in the field in the pair of poles in the stator larger and increasing the number of turns in the center coil and adjusting the turns in the auxiliary coils.

13. The winding in electric machine with center coil according to claim 10, wherein a universal motor and a DC motor with a coil in each one of the two poles in the pole pair in the stator join the two coils in one center coil in field center, and the 2 short-circuited coils separate, in 4 slots in the rotor, are united in two opposing radial slots in the rotor.

14. The winding in electric machine with center coil according to claim 10, wherein the power of the electric machine is determined on the basis of its core area in the rotor elevated to the square, comprising the rotor diameter multiplied by the width of the rotor.

15. The winding in electric machine with center coil according to claim 10, wherein to make the power of a coil in the electric machine, elevating to the square its corresponding core area in the rotor by setting the number of turns proportional to the core area, which is the effective width of the rotor multiplied by the length of the chord in the rotor between the two lines from the center of rotor to the two centers of this coil in the stator.

16. The winding in electric machine center coil according to claim 10, wherein the distance between a slot in the stator and the outer surface of the stator depends on function of the square root of the power in the coil in this slot.
